(19) United States
(12) Patent Application Publication
(10) Pub. No.: US 2011/0168164 A1
(43) Pub. Date: Jul. 14, 2011

(54) IN SITU REGOLITH GAS RECOVERY SYSTEM

(76) Inventors: Andrew J. Zillmer, Woodland Hills, CA (US); Joseph P. Carroll, Moorpark, CA (US)

(21) Appl. No.: 12/684,297

(22) Filed: Jan. 8, 2010

(51) Int. Cl. F24J 2/52; F24J 2/02; F24J 2/06; G05D 7/00

(52) U.S. Cl. 126/600; 126/683; 126/685; 137/1; 137/561 R

(57) ABSTRACT

A system for releasing and capturing gases from a regolith material has a frame that is movable to define a capture space on a regolith material. A mirror captures solar energy, and focuses energy through a lens and on a regolith defined within the captured space. Apparatus is provided for capturing released gas. A method of operating such a system is also disclosed and claimed. In addition, a method of forming structural material is also disclosed and claimed.

### BACKGROUND OF THE INVENTION

This application relates to a transport vehicle which is movable on a surface, such as a lunar surface, to bring a gas recovery system onto an area of regolith, and then to utilize solar power to release gases, and to recover those gases.

The field of space travel, colonization, and establishing space stations, carries several logistic challenges. One challenge with implementing stations on the moon, or other non-earth bodies, is the need to transport all required gases, supplies, etc.

As an example, transporting all the required gases to a lunar station would require a great deal of storage space on vehicles traveling to the moon.

On the other hand, it is known that the lunar surface, and in particular its regolith, or loose rock and dust on the surface, includes a great deal of recoverable gases.

It has been proposed to utilize solar energy to release, capture, and utilize those gases. However, the systems proposed to date have not been practical.

### SUMMARY OF THE INVENTION

A system for releasing and capturing gases from a regolith material has a frame that is movable to define a capture space on a regolith material. A mirror captures solar energy, and focuses energy through a lens and on a regolith defined within the captured space. Apparatus is provided for capturing released gas. A method of operating such a system is also disclosed and claimed. In addition, a method of forming structural material is also disclosed and claimed.

These and other features of the present invention can be best understood from the following specification and drawings, the following of which is a brief description.

### BRIEF DESCRIPTION OF THE DRAWINGS

FIG. 1A is a first view of a transport vehicle for use in recovering gases from regolith.

FIG. 1B is an enlarged portion showing one part of the FIG. 1A embodiment.

FIG. 2 shows a further detail of the FIG. 1A embodiment.

FIG. 3 shows a path of solar energy as utilized in this application.

FIG. 4 shows a step subsequent to the FIG. 1A step.

FIG. 5 shows the use of blocks created by melted regolith.

### DETAILED DESCRIPTION OF THE PREFERRED EMBODIMENT

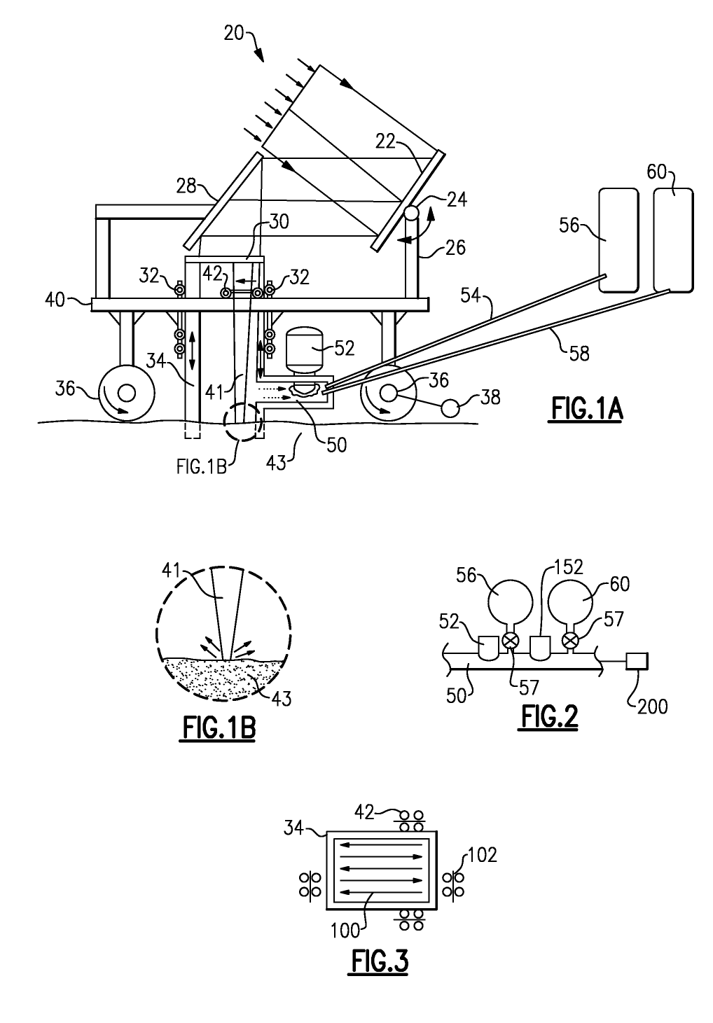

FIG. 1A shows a system 20 for recovering gases from a regolith material 43, such as found in the first several meters of the surface of the moon, and other space bodies. As shown, the system 20 includes a solar acquisition mirror 22 driven by a motor 24 (shown schematically) mounted atop support 26, and operable to locate the sun's ray optimally, and to direct those rays toward another turning minor 28, which is driven by its own motor. Controls for properly aligning the two minors may be as known.

A focusing lens 30 is mounted atop a movable frame 34. The movable frame 34 is movable through motors and guides 32 to translate vertically upwardly relative to a housing 40 of the system 20. Wheels 36 are provide with a motor 38 (shown schematically) and operable to move the entire system along the surface.

The lens 30 creates a ray 41 directing high intensity solar energy onto the outer surface of the regolith 43.

It is well known that the lunar regolith includes large quantities of numerous gases. As an example, there is a good deal of H₂ which can be useful as fuel. In addition, H₂O, N₂, C0₂, CH₄, Ar, He, and CO are all recoverable to be utilized for various life support functions. In addition, helium 3 and deuterium can be isolated from the regolith, and utilized for fusion energy (such as back on earth) and cryogenics, respectively.

The solar energy ray 41 is shown in FIG. 1B being directed at the regolith. It is believed that temperatures on the order of 700°-800° C. (1292°-1472° F.) or higher can be achieved with such a system.

The gases released within the frame 34 are captured, as the frame 34 has been moved downwardly to be buried within the upper surface of the regolith 43. The frame thus defines a capture space. The gases then travel into a capture tube 50. Capture tube 50 is provided with at least one cryocooler 52. By cooling the gases, the several released mixed gases can be separated into their individual components, which can then be tapped into capture lines 54 and 58, leading to gas/liquid storage tanks 56 and 60. Alternatively, capture tube 50 may contain a turbopump 200 to remove gases from the chamber. The capture tube may also consist of both a cryocooler and a turbopump to remove and collect the gases released from the regolith.

In addition, the gases may be separated individually as the temperature of the regolith increases. That is, certain gases may be released at a particular low temperature, while other gases are released at a higher temperature. Thus, the separate gases may reach the capture tube serially, and thus be easier to separate.

FIG. 2 shows a better view of the gas recovery along tube 50. As shown, there is a first cryocooler 52 which will cool the gas downwardly to a first temperature. This will release a particular gas, which can be captured into a storage tank 56. A valve 57 is positioned to isolate the line leading to the container 56. A second cryocooler 152 may then further cool the mixed gases such that another gas can be released and captured in is own storage tank 60, provided with its own valve 57. In this manner, a number of gases can be recovered from the regolith. More than two cryocoolers can be used in series. This process is like a distillation column. The first gas can be condensed out and collected while the rest of the gases are left to flow on. This will allow for separation of gases by constituent types.

In addition, and rather than utilizing the methods as set forth above to capture the gases, turbo pumps or vacuum pumps may be utilized. Again, any number of ways of separating and capturing the gases can be utilized.

FIG. 3 schematically shows the movement 100 of the ray 41 within an enclosure defined by the housing 34. As shown, the lens may be movable along motor and guides 42 and 102 such that it can move backward and forward, and translate laterally within the boundaries of frame 34. A linear Fresnel lens could also be used, which could simplify the movement down to a single pass.

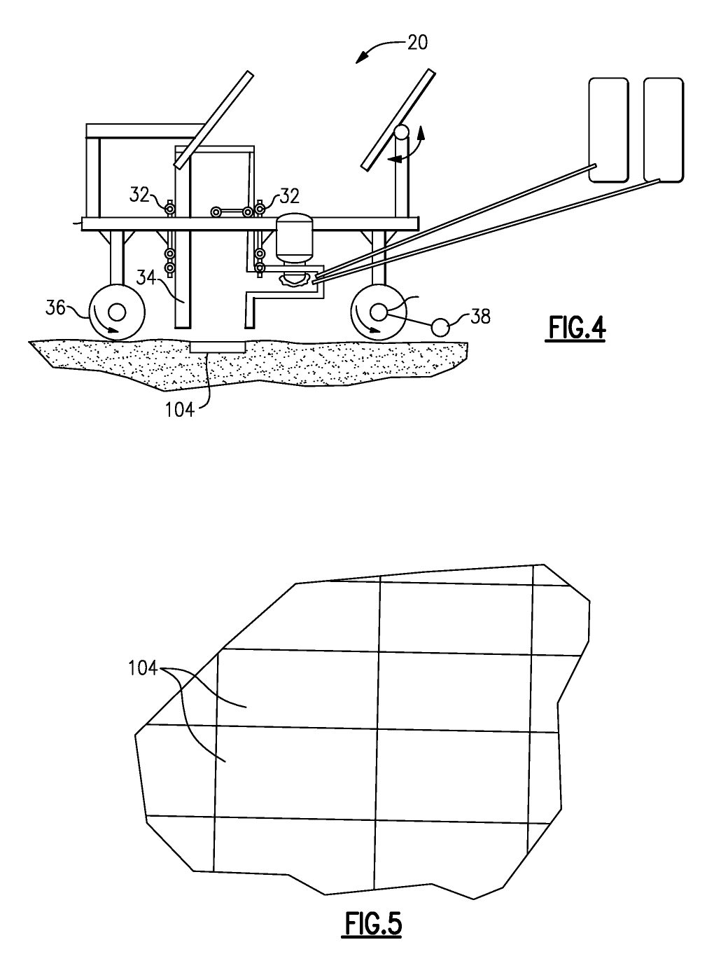

At some point, all of the recoverable gases from that portion of regolith captured within the housing 34 will be processed. At that point, the housing 34 may be retracted vertically upwardly out of the regolith, as shown in FIG. 4. The system 20 may then be driven to a new location, such as adjacent to the prior area 104.

The regolith left may be melted, and thus may be within the form of a tile of relatively rigid material. This melted tile can be utilized as shown in FIG. 5 to create a platform, such as for use in other applications on a space station.

While the tiles 104 may be moved to create the platforms, it is also possible to simply utilize the system 20 on a number of adjacent areas to form a solid platform of melted regolith.

The overall system as described in this application thus not only captures gas, which now does not need to be transported from the earth to the space station. In addition, the “waste” forms tiles 104, which can be utilized for building purposes such as shown in FIG. 5.

Rather than utilizing lenses that are mounted within the frame, lenses outside the frame can direct rays through the window. In addition, rather than utilizing a pair of minors 22 and 28, a single minor arrangement could be utilized. Further, heat exchangers can be incorporated into the gas collection process to capture heat for re-use in various other applications.

Although embodiments of this invention have been disclosed, a worker of ordinary skill in this art would recognize that certain modifications would come within the scope of this invention. For that reason, the following claims should be studied to determine the true scope and content of this invention.

What is claimed is:

1. A system for releasing and capturing gases from a regolith material comprising:
a movable frame, said movable frame being movable such that it can be moved to define a capture space on a regolith material;
a mirror for capturing solar energy, and focusing the captured solar energy through a lens and on regolith defined within the capture space to release gas; and
apparatus for capturing released gas.

2. The system as set forth in claim 1, wherein said movable frame is movable vertically on a vehicle which can be driven along the surface of the regolith.

3. The system as set forth in claim 1, wherein said system includes structure to move a ray of the energy within the capture space.

4. The system as set forth in claim 1, wherein a first mirror captures solar energy, and directs the captured solar energy to a turning minor, which in turn focuses the captured solar energy onto a focusing lens.

5. The system as set forth in claim 1, wherein the apparatus includes at least one cryocooler which cools released gases such that the gases can be captured into their component materials.

6. The system as set forth in claim 5, wherein there are a plurality of coolers set to different temperatures to release distinct gases to be separately captured.

7. The system as set forth in claim 1, wherein a pump removes the captured gas to a location for storage.

8. The system as set forth in claim 1, wherein said movable frame is provided with a motor and guide to be translated vertically relative to a movable platform.

9. The system as set forth in claim 8, wherein said focusing lens is provided with a series of motors and guides such that said focusing lens can be translated in two dimensions within the boundaries of said capture space.

10. A method of releasing and capturing gases from a regolith material including the steps of:
moving a frame to define a capture space on a regolith material;
capturing solar energy, and focusing the captured solar energy through a lens and on regolith defined within the capture space to release gas; and
capturing released gas.

11. The method as set forth in claim 10, wherein said frame is moved vertically on a vehicle which can be driven along the surface of the regolith.

12. The method as set forth in claim 10, wherein the captured energy is moved movable within a boundary defined by capture space.

13. The method as set forth in claim 10, wherein a first minor captures solar energy, and directs the captured solar energy to a turning minor, which in turn focuses the captured solar energy onto a focusing lens.

14. The method as set forth in claim 10, further including the steps of capturing the released gas by cooling the released gas to separate out individual gases from a combination of released gases.

15. The method as set forth in claim 14, wherein a plurality of coolers cool the combined released gas to different temperatures to individually release and capture individual gases.

16. A method of providing structural material for use in a remote location comprising the steps of:
(a) providing solar energy onto a regolith surface on the remote location, and at very high temperatures;
(b) heating the regolith material such that it melts within the boundaries of a housing; and
(c) allowing the regolith to cool, and utilizing the cooled previously melted regolith as a structural material.
